(19) United States
(12) Patent Application Publication
(10) Pub. No.: US 2012/0179692 A1
(43) Pub. Date: Jul. 12, 2012

(54) System and Method for Visualizing Sentiment Assessment from Content

(75) Inventors: Ruey-Lung Hsiao, Los Angeles, CA (US); Eugene B. Shirley, JR., Los Angeles, CA (US)

(73) Assignee: Alexandria Investment Research and Technology, Inc., Los Angeles, CA (US)

(21) Appl. No.: 13/349,460

(22) Filed: Jan. 12, 2012

Related U.S. Application Data
(60) Provisional application No. 61/432,162, filed on Jan. 12, 2011.

(51) Int. Cl. G06F 17/30

(52) U.S. Cl. 707/748; 707/E17.084

(57) ABSTRACT

Methods, systems, and apparatus, including medium-encoded computer program products, provide visualizations of sentiment assessments derived from content published online. In one or more aspects, a method includes: obtaining sentiment scores and associated data, the sentiment scores assigned to entities based on emotional tone detected in obtained content; obtaining input defining a subset of the sentiment scores and associated data to present; and outputting a visualization corresponding to the subset of the sentiment scores and associated data. In addition, obtaining the input can include receiving a definition corresponding to company relationships used to filter the sentiment scores and associated data. The definition can include an indication of which relationship types indicate the company relationships, and parameters that govern filtering by the indicated company relationships. The relationship types can include supply chain relationship, credit relationship and common director relationship, and the company relationships can include company-company relationships, company-individual relationships and individual-individual relationships.

### CROSS-REFERENCE TO RELATED APPLICATIONS

This application claims the benefit of the priority of U.S. Provisional Application Ser. No. 61/432,162, filed Jan. 12, 2011 and entitled “SYSTEM AND METHOD FOR VISUALIZING SENTIMENT ASSESSMENT FROM CONTENT”.

### BACKGROUND

This specification relates to organizing, filtering, and accessing content in a knowledge management system.

Various knowledge management systems have been implemented using different approaches to content classification, as well as different approaches to viewing the data contained in the system. Numerous methods have been developed to address content categorization and visualization. These methods have included the use of both symbolic knowledge representation and statistical machine learning techniques.

### SUMMARY

This specification describes systems and methods relating to organizing, filtering, and accessing content, such as in a knowledge management system. An example knowledge management system is described in detail in U.S. patent application Ser. No. 12/989,756, entitled “ADAPTIVE KNOWLEDGE PLATFORM”, which is hereby incorporated by reference, and is published as US 2011-0264649 A1.

In general, one or more aspects of the subject matter described in this specification can be embodied in a method that includes: obtaining sentiment scores and associated data, the sentiment scores assigned to entities based on emotional tone detected in obtained content; obtaining input defining a subset of the sentiment scores and associated data to present; and outputting a visualization corresponding to the subset of the sentiment scores and associated data. Obtaining the sentiment scores and associated data can include receiving the sentiment scores from a separate sentiment assessment system that automatically gathers, manages, and analyzes the content, which includes at least one of content published online or private content provided by third parties, wherein the sentiment scores are numeric values determined by the separate sentiment assessment system. The private content provided by third parties can include proprietary content obtained through one or more subscriptions to content provider services, as well as emails, telephone call transcripts or recordings, etc. Moreover, the entities can include companies, sectors, industries and countries, and obtaining the input can include receiving the input through a user interface configured to allow slicing of an entire dataset according to various criteria, including countries, sectors, market capitalization, and time.

Obtaining the input can include receiving a definition corresponding to company relationships used to filter the sentiment scores and associated data. Receiving the definition can include: receiving an indication of which relationship types indicate the company relationships; and receiving parameters to govern filtering by the indicated company relationships. The relationship types can include supply chain relationship, credit relationship and common director relationship, and the company relationships can include company-company relationships, company-individual relationships and individual-individual relationships.

Outputting the visualization can include charting sentiment scores derived from a common data source at different times. Outputting the visualization can include charting sentiment scores derived from different data sources. Outputting the visualization can include charting sentiment scores of one or more of the entities in relation to another measure of absolute value for the one or more entities. Moreover, outputting the visualization can include generating a heat map user interface having reconfigurable X and Y axes, one or more drill down interfaces, and three dimensional display settings that show content volume on a Z axis.

Other embodiments of these one or more aspects include corresponding computer program products, apparatus, and systems. For example, a system can include a user interface device; and it can include one or more computers operable to interact with the user interface device and to perform the method operations. Moreover, other embodiments can include a computer-readable medium encoding a computer program product operable to cause data processing apparatus to perform the method operations.

Particular embodiments of the subject matter described in this specification can be implemented to realize one or more of the following advantages. A sentiment assessment system can help users to handle information overload by automatically gathering, managing, assessing, analyzing, and displaying qualitative information in addition to existing qualitative information. The system can include front-end and back-end components, where most of the data analysis and manipulation can happen in the back-end component, while the front-end component is primarily responsible for displaying information and for user interaction. The system can use a two-tiered client-server architecture, and can be capable of handling large amounts of qualitative content, including news feeds (e.g., on the order of 15,000 articles a day for atypical newswire), Securities and Exchange Commission (SEC) filings (e.g., on the order of thousands per day), company reports, wires, Really Simple Syndication (RSS) news feeds, blogs, Tweets, emails, subscribed research reports and other Internet content from around the world. Moreover, the algorithms used can take into account meaning and context rather than simply relying on the rote value of individual words. The algorithms can extract facts, relationships, and emotional content that may have an affect on market behavior. Operating around the clock, the system is capable of reading an article in roughly 10 milliseconds or less.

An information extraction system can be used to identify critical intelligence in a data stream of information, e.g., about company relationships, leadership changes, earnings, etc. Content can be tagged using a methodology that can assure accuracy, consistency, and scalability across diverse sources of information. In the sentiment engine, content can be assessed for its “sentiment,” which is to say, the emotional tone of news that may have an effect on business (whether it's identifying opportunity or signaling risk). Sentiment can be scored numerically for companies, sectors, industries, countries and even asset classes, and this sentiment scoring can be done in real time. The speed and accuracy of the sentiment-scoring (e.g., over 90%) can help investors to anticipate where and when the crowd is moving. In addition, integrated intelligence can be delivered with concise, targeted valuations investors can put to direct use, advanced visualization and knowledge management tools can help investors track vulnerable relationships, identify risks, and follow trends. Moreover, mapping technology can guide an investor to hot spots where they can drill down to granular levels.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows example networks and apparatus with which the described system(s) can be implemented.

FIG. 2 shows an example of an architecture for a sentiment assessment system.

FIG. 3 shows an example of a News view in a user interface of a sentiment assessment system.

FIG. 4A shows an example of a Country view in a user interface of a sentiment assessment system.

FIG. 4B shows drilling down into the Country view in the user interface of the sentiment assessment system.

FIG. 4C shows the use of information panels and the control panel in the user interface of the sentiment assessment system.

FIG. 4D shows a three dimensional viewing option for the user interface of the sentiment assessment system.

FIG. 4E shows an example where the Snapshot function has been used in the user interface of the sentiment assessment system.

FIG. 5A shows an example of a Terrain view in a user interface of a sentiment assessment system.

FIG. 5B shows drilling down into the Terrain view in the user interface of the sentiment assessment system.

FIG. 5C shows an example of how users can change the definition of the axes and filters to alter the display in the sentiment assessment system.

FIG. 5D shows another example of how filtering can be used in the sentiment assessment system.

FIG. 6 shows an example of a Correlations view in a user interface of a sentiment assessment system.

FIG. 7A shows an example of an Intelligence view in a user interface of a sentiment assessment system.

FIG. 7B shows the Intelligence view in the user interface of the sentiment assessment system with two companies' relationships displayed.

FIG. 7C shows the Intelligence view in the user interface of the sentiment assessment system with additional relationships discovered by the system between these two companies and among their related companies.

FIG. 8 shows an example of a Detail view in a user interface of a sentiment assessment system.

FIGS. 9A-9E shows an example of a Dashboard view in a user interface of a sentiment assessment system.

Like reference numbers and designations in the various drawings indicate like elements.

### DETAILED DESCRIPTION

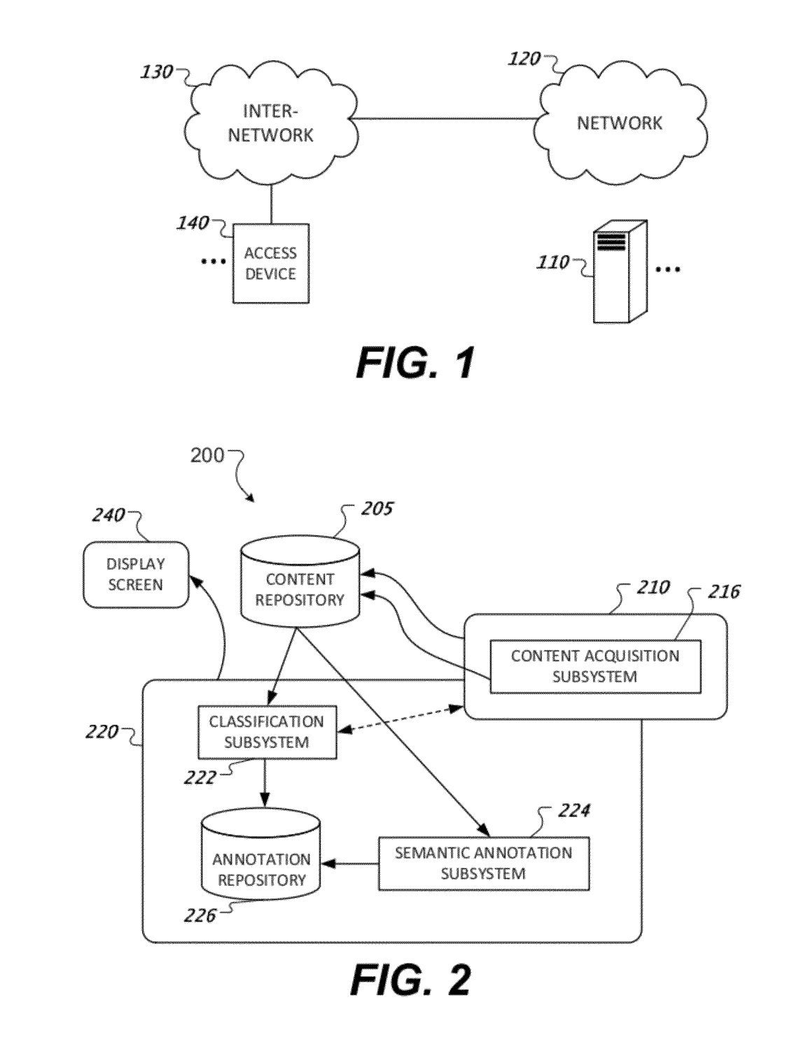

FIG. 1 shows example networks and apparatus with which the described system(s) can be implemented. One or more server computers 110 can be provided to store data and supply the described functionality. The server computer(s) 110 can be a server cluster, a single server computer, and/or distributed geographically. Note that the use of the word “server” does not imply that the computer(s) 110 need be expensive, high-end servers, but rather, simply that the computer(s) 110 serve up data and functionality upon request. The server(s) 110 can be general purpose personal computers that have been appropriately programmed.

The server computer(s) 110 can be connected to a network, which can be a proprietary network (e.g., an Ethernet based enterprise network) or a public network (e.g., the Internet). In the example shown, the server computer(s) 110 are connected with a local area network 120, which in turn is connected to an inter-network 130. One or more access devices 140 can connect with the inter-network 130 to gain access to the data and functionality provided by the server computer(s) 110. The access device(s) 140 can include personal desktop computers that connect to the inter-network 130 through a wired connection (e.g., a cable modem, Digital Subscriber Line, or T1 line) and mobile computers (e.g., laptop, mobile phone, personal digital assistant, etc.) that connect to the inter-network 130 through a wireless connection. As will be appreciated, many other hardware systems and networks are also possible.

Using knowledge assessment and extraction, knowledge management, and advanced information visualization technology, the sentiment assessment system can aid portfolio management, securities research, risk assessment, and comparative analysis (comparing sentiment scores derived from the same data source but from different time periods; sentiment scores from different data sources; sentiment scores in relationship to other kinds of data, such as stock price or a country's Gross Domestic Product (GDP), etc.). FIG. 2 shows an example of an architecture for a sentiment assessment system 200. The sentiment assessment system 200 can provide a systemic and aggregated approach to acquiring, assessing, and presenting information. Various input subsystems can connect with, and provide data to, a content repository 205. These input subsystems can be integrated together to form a knowledge aggregator 210 that works with various processing subsystems 220 to automatically acquire, filter and classify content to support content assessment in the sentiment assessment system.

The knowledge aggregator 210 can include various subsystems to acquire data from multiple different sources. This can include a content acquisition subsystem 216 that can automatically retrieve new content in accordance with specified criteria. For example, the content acquisition subsystem can target user-determined high-value content sources (such as current affairs feeds or new material that has recently been added to the curriculum of a course) and automatically acquires relevant pieces of information. The content acquisition subsystem can retrieve data from RSS (Really Simple Syndication) feeds, Web searches, focused site monitoring, and crawler-based information discovery, in addition to private files, specialist information (such as scientific papers, financial, and legal information), and multimedia sources, as well as sources that utilize languages other than English. Content collected can include quantitative information (such as mathematical and financial data), unstructured qualitative information (such as natural language content related to media, human conversation, reports, blogs, etc.), and information that is both qualitative and quantitative by nature. Relevant content sources can be determined by: (1) the system designers, (2) the targeted system license-holder, and/or (3) system users (which can be through direct user input or indirect feedback through, for example, the evaluation system).

The processing subsystems 220 can include a classification subsystem 222 and a semantic annotation subsystem 224 that interact with an annotation repository 226. The semantic annotation subsystem 224 can capture the semantic meaning of, and contextual relationships among, various pieces of the content stored in the content repository 205. The classification subsystem 222 can automatically categorize new content using, at least in part, the semantic annotation subsystem 224. As a result, new content coming into the system can be automatically organized, thus allowing new platform content to become dynamic, without consuming large amounts of human time in processing it.

The semantic annotation subsystem 224 can provide an environment for semantic annotation of all content managed by the knowledge platform. The semantic annotation subsystem 224 can include one or more annotation tools that support an integrated approach to categorical annotation (e.g., by media type, key words, etc.) and semantic annotation through the use of ontological hierarchies. The semantic annotation subsystem 224 can also include a user interface that brings together (e.g., in one display screen) content designated to be annotated with a range of semantic annotation tools in support of accurate and efficient contextual annotation.

Content can be obtained from the input subsystems 210 and stored in the content repository 205. The processing subsystems 220 can then annotate the new content with metadata and ontology associations in a manual or automatic fashion. As indicated by the dashed line in FIG. 2, the content acquisition subsystem 216 can use the classification subsystem 222 to do content filtering, topic identification, etc. In addition, a user interface 240 can retrieve and visualize data from the processing subsystems 220 (or other subsystems of the sentiment assessment system). The user interface functionality can be provided by one or more servers separate from the one or more servers providing the sentiment scoring and data. Elements of the user interface can also operate at an appropriate access device 140. Thus, the user interface 240 can be local or remote to the sentiment scoring system and provides access to the sentiment assessment service (e.g., a back-end and front-end system). The right-hand side of the user interface 240 can contain a Control Panel that, depending on the navigation window operating at the time, can contain all or a portion of the following functions:

Display: This relates to the display of the visual information on the screen, Refresh/apply button activates settings. Reset—Resets Layout to starting position for a selected time interval. 3D—Shifts to 3D layout. 2D—Shifts to 2D layout (the default setting is for 2D). Hide Unselected—When selecting a given territory, Hide Unselected reduces clutter by hiding all other (i.e., unselected) regions or countries. Show All—Undoes the Hide Unselected function to display all regions and countries.

Interval: a section of the panel allows users to select and change the relevant time periods to display. The default time period is the current day. Streaming news is incorporated into the system in specified frequencies (the default is every two minutes). To select a Time Interval, the user may quick select a time period from the drop down menu, select a date from the calendar, or key in a desired date. The Refresh button will apply the time changes for display.

Input Data: This allows the user to specify the data to be displayed within the universe. Load Universe—selects a specific universe of data within the database to load. Link Client Data—link to client's database for additional information, such as price, market cap, model rank, sectors, etc.

Target Period: This refers to the interval for the sentiment statistics that the user desires to display.

Prior Period: This refers to a secondary period (likely used for comparative purposes only) for such items as “change in news stories,” or “changes in sentiment.”

Axes: This function gives users the opportunity to specify the kind of data associated with the X, Y, and Z Axes. Default settings are as follows: Z—Number of stories for the given period; X—Time period; Y—Associated monetary value (for a territory, this value may be the GDP; for a stock, it may be the price). Color—Sentiment score as associated with the visualization. Size—Individual node size signals a single news instance.

Filters: this allows users to filter the information universe for Sentiment, Performance, or Model Rank: Drop down function allows users to select filter type. Min—creates a floor value and allows users to filter for values greater than this number. Max—creates a ceiling value and allows users to filter for less than this number. Apply—applies the new filter settings to data in the database. Add Focus—specifies the territory to view.

News: this provides some user control of news headlines for universe items (Countries or Stocks). Headline is color coded for sentiment: Double click to retrieve the news story.

Control Panel Display Functions Unique to Terrain View: Load: Loads universe of stocks.

Control Panel Functions Unique to Correlations: Perspective—Choose sentiment statistic. (Default is story count. The VI sentiment score is in the drop down menu.) Filters—Allows user to input company ticker. Moving Average—Sets moving average value(s).

Control Panel Functions Unique to Intelligence. Search: Type in company name or ticker or an individual's name; double click Person or Company to add them to the screen; default number of companies is 10. Graph: Allows user to specify the relationship to display upon load: User may select between person or company. Details: Shows all relationships for the company specified.

Drill-Down Functions: Utilizing a computer mouse, this allows users to drill down into a given territory in the Country or Terrain views and explore its component parts in detail. Double Click on any region to drill down to explore the countries that compose the region; the industries that compose a sector; the companies that compose an industry. Double Click on any country or company to see news (or other content) stacks for hours (intra-day) and days (multi-day) for the period selected. Click on any node composing a news stack to open the news in a drop down window in the Control Panel. Associated dates are displayed below news stacks.

Drill Down Features Unique to Terrain View: Daily performance listed below each date and color coded for positive/negative values.

Mouse Functions: Mouse functions vary according to the primary system window in operation. Hence, the following controls are operational options based on the window currently in use: Right Click: These opportunities open to users: Center—Zoom function over territory; Merge—Move up (opposite of drill down) to previous level of the hierarchy; Label—Toggle key hides parent labels (also “L” on keypad); Price Date—toggle key hides date labels (also “D” on keypad); Overlay Detail—hides the Information Panel.

Right Click Functions Specific to the Terrain View: Examine In: Details, Correlations, Intelligence—Jumps to Additional functions and loads data for security selected; Related Companies: Displays related companies as defined by database.

Right Click Functions Specific to the Intelligence View: Delete—Deletes node from screen; Add Suppliers—Adds up to 10 more suppliers each time selected; Add Customers—Adds up to 10 more customers each time selected; Add Board Members—Adds up to 10 board members each time selected; Add Employees—Adds up to 10 executive employees each time selected; Find Companies—Adds up to 10 companies for the board member or executive each time selected.

Right Click Functions Unique to Correlations: Sentiment Series—Adjusts sentiment statistic to histogram or line plot; Show Trace Lines—Shows trace lines on screen.

Right Click Functions Unique to Intelligence View: Delete—Deletes node from screen; Add Suppliers—Adds up to 10 more suppliers each time selected; Add Customers—Add up to 10 more customers each time selected; Add Board Members—Adds up to 10 board members each time selected; Add Employees—Adds up to 10 executive employees each time selected; Find Companies—Adds up to 10 companies for the board member or executive each time selected. Details—Shows all relationships for the company specified.

Mouse Wheel: Wheel Toward User—Zoom in; Wheel Away from User—Zoom out.

Keyboard Functions: L—Hide/Reveal parent labels; D—Hide/Reveal date and performance labels; H—Hide all non-selected items; S—Show all items; CRTL+Mouse Click—Make multiple selections; Up/Down Arrow—Toggle forward/backward; Left/Right Arrow—Rotate clockwise/counterclockwise.

According to some implementations, the opening screen of the primary system window can reveal the following navigation tabs at the top: News; Country; Terrain; Correlations; Intelligence; Detail; Dashboard. The operational goal of the system can be to enable users to view the data from different perspectives, according to different user needs. It is similar to the roll-up and drill-down operation in database OLAP (Online Analytical Processing). That is, users may view sentiment data by slicing the entire dataset according to various criteria, such as relevant countries, sectors, market cap, time, etc.

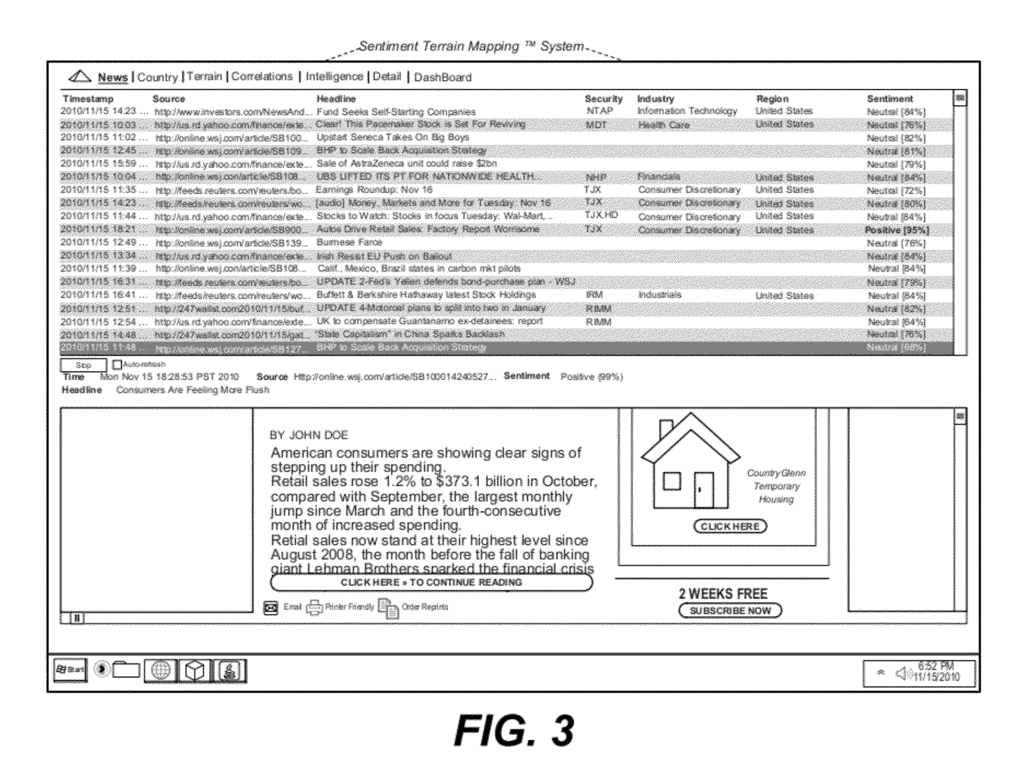

The default view of the opening screen can be the News tab. FIG. 3 shows an example of a News view in a user interface of a sentiment assessment system. In this view, the user sees real-time data feed inputs (such as news stories from any of the data feeds being accessed) substantially immediately after they have come into the system and have been processed by it (this takes roughly 10 milliseconds per article). To start inputs, users click the Start button. Streaming items flow in real time into the upper section of the screen. Here, they are identified according to: Headline of individual data feed inputs (such as news articles); Source of input; Timestamp of the data; Region; Security; Industry; Sentiment (scored by a back-end system).

Columns may be resized to user specifications using the common click-and-drag method. If users double-click a headline, its related news article will appear in the lower portion of the screen, as shown. As the figure suggests, the system is capable of displaying and analyzing multilingual information.

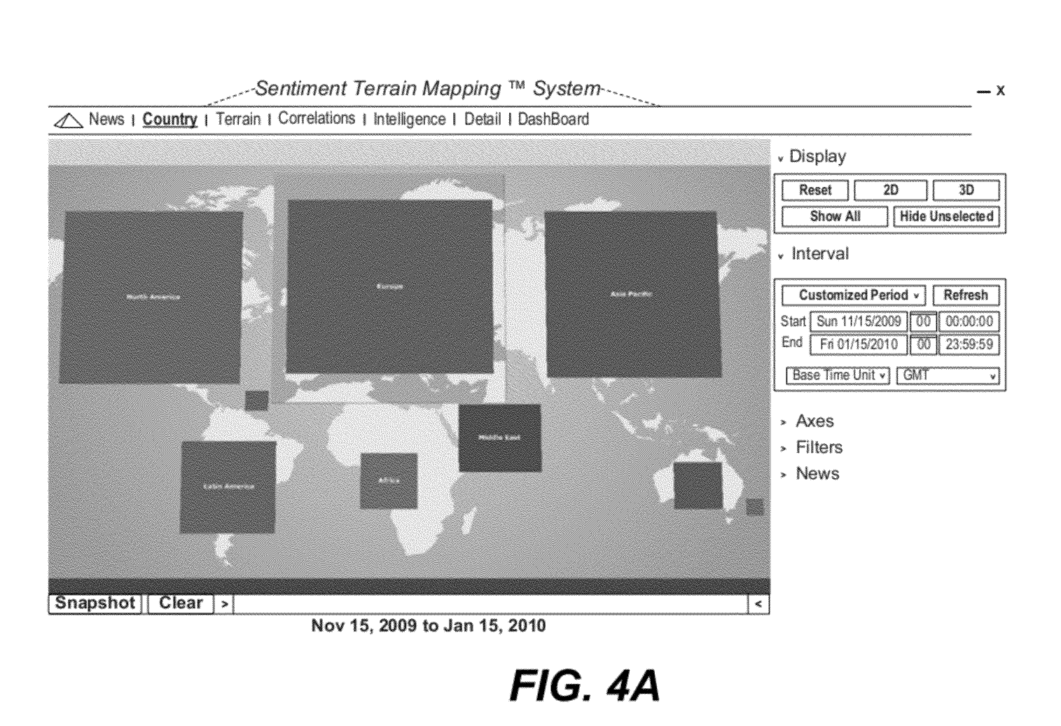

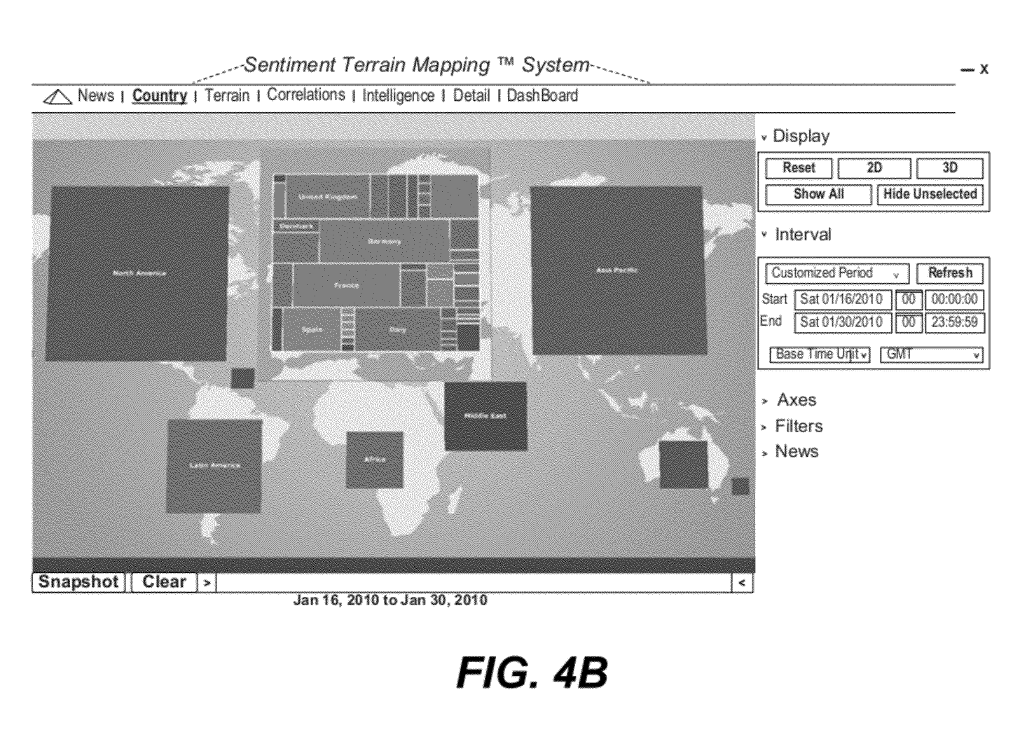

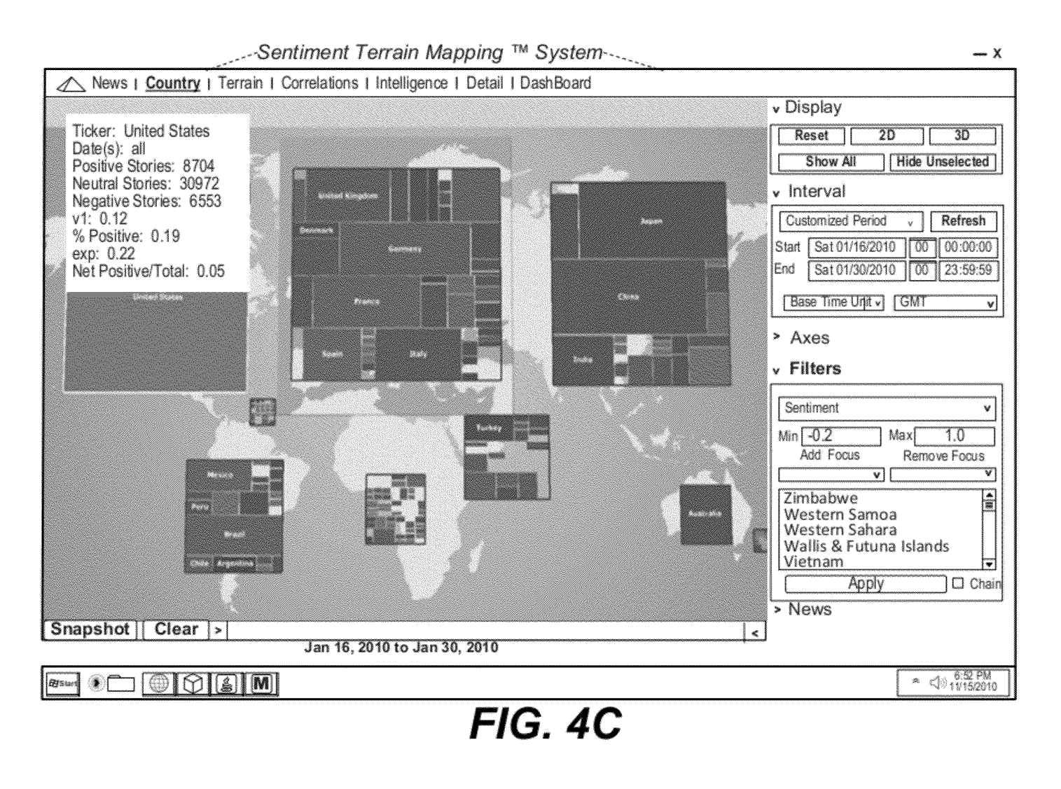

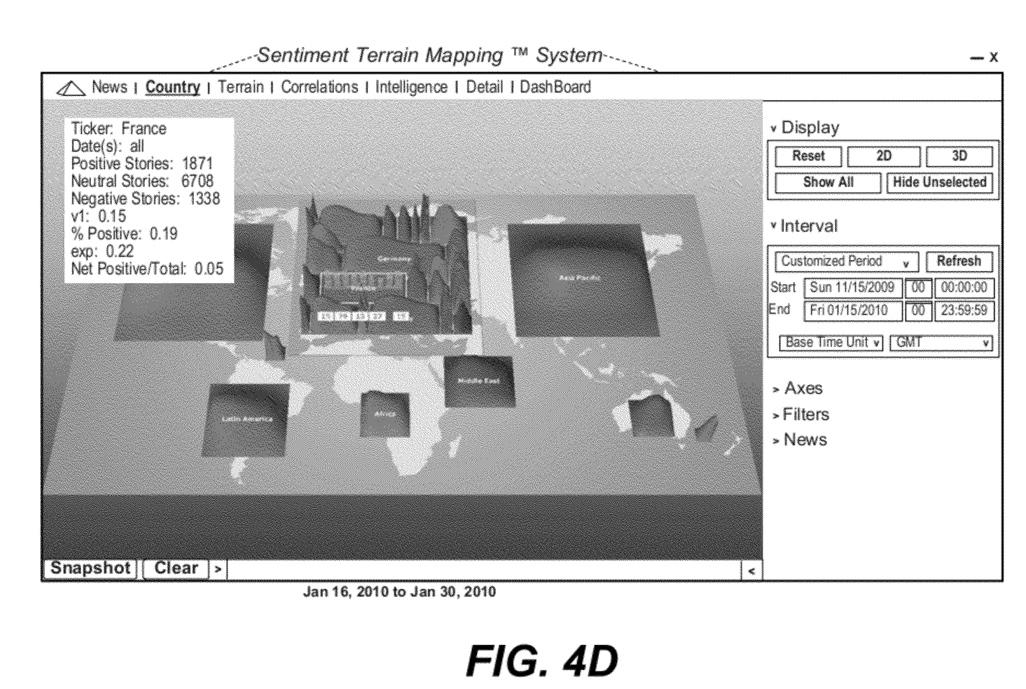

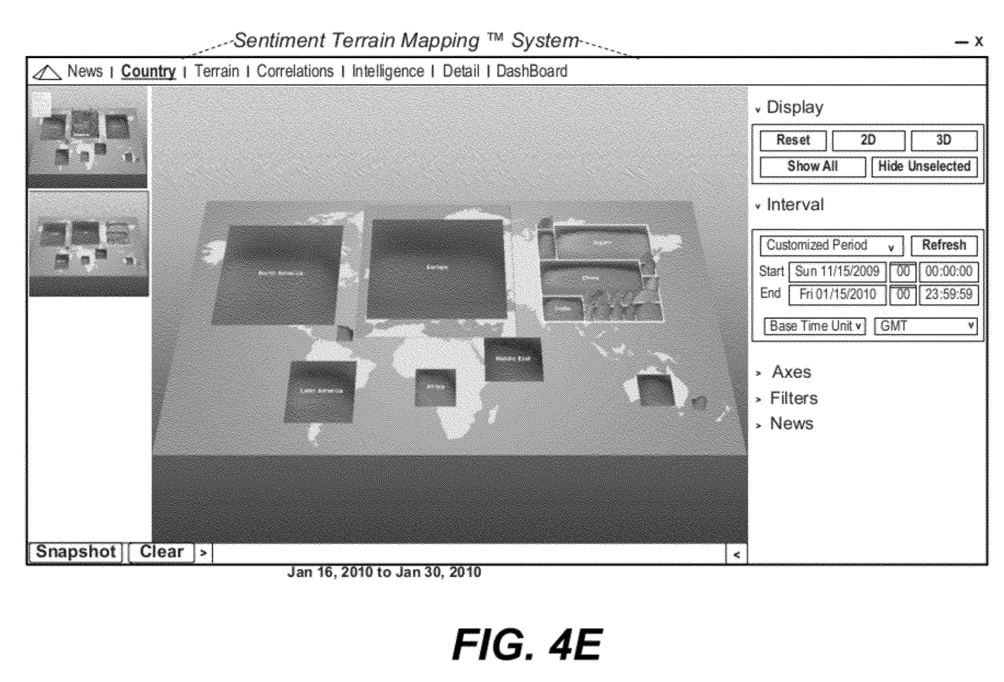

FIG. 4A shows an example of a Country view in a user interface of a sentiment assessment system. In this panel, users may view the sentiment associated with data feed inputs (as scored by the back end systems) aggregated into regions and countries weighted by user-specified criteria (GDP is the default setting). Information is visualized using a two dimensional (2D) world map combined with a heat map (in the default setting, country size is determined by GDP) overlaid on the world map. The overlay places the heat map for each country in a location that approximates that country's geographical location. The approximate geographical placement makes it easy for users quickly to find countries they are looking for; the heat map treatment of each country makes it easy for users to assess relative significance as determined by GDP or other settings. Each heat map view of each territory is visually tagged for its affiliated region or country.

In the information visualization display, time is a function of the X axis—such that, within any given territory (e.g., country), one may view sentiment change over any given period of time (as determined by the user). A time slider bar at the bottom of the page makes it easy for users to isolate time periods within the intervals selected.

The default option associates the Y axis only with a single data feed source. The Y axis may be used in any number of additional user-directed ways. For example, various sources of data may be placed along this axis; it may be used to track a change in GDP; it may be used to signal the importance of a given territory to the user (e.g., in territories of greatest importance, sentiment information may be placed lower on the Y axis, while less important territories may have their sentiment information placed higher on the Y axis, etc.), etc.

The color of any given heat map territory can be determined by the assessed sentiment score, for the selected period, of the relevant territory, e.g., as determined by the back-end system. Green tones signal a range of positive sentiment (the purest green represents the strongest positive sentiment); red tones signal a range of negative sentiment (the purest red represents the strongest negative sentiment); grey tones signal neutral sentiment, with some combination of grey-red signaling a mix of negative and neutral sentiment scores and some combination of grey-green signaling a mix of positive and neutral sentiment scores. The idea is for color tones to quickly communicate to users the sentiment assessment of data for the territory(ies) they are interested in.

FIG. 4B shows drilling down into the Country view in the user interface of the sentiment assessment system. As shown, a user is able to drill down into each geographical region to investigate its component parts. This is accomplished by double clicking on the area associated with the region. Again, each area is sized by its GDP (in the default setting) with color representing the sentiment scores of regions and sub-regions/countries.

FIG. 4C shows the use of information panels and the control panel in the user interface of the sentiment assessment system. In the upper-left corner of the screen is an information panel showing detailed information of the territory selected by the user, including: Stock ticker; Time interval; Number of positive, negative, and neutral stories; the assessed sentiment score; Percentage of positive news count. The default Information Panel contains information for the entire period of time that the user has selected.

On the right-hand side is the control panel. This grants user control over time period, axis definition, and filters and provides users with access to lists of stories that, combined, constitute the overall sentiment of any territory the user is interested in. Also shown in FIG. 4C is a particular use of the filters: e.g., to display only those regions with sentiment scores between −0.2 to 1.0. Regions that do not meet the criteria do not show up in the 2D heatmap.

FIG. 4D shows a three dimensional (3D) viewing option for the user interface of the sentiment assessment system. When this option is selected by the user, the 2D environment turns into a 3D landscape. In the 3D view, the information associated with the X and Y axes remains the same as in the 2D view. The 3D view, however, creates a new axis, Z, which allows the user to distinguish new information: height. Height signifies the volume of new stories for a given period of time as defined within a given territory. Visually, the height is represented by individual inputs of data, or nodes (one node per individual input), “stacked” into columns (if composed of news stories, then “story stacks”) for any given period of time. Displaying the data this way allows the user to quickly gain a visual impression of the volume of inputs associated with any territory. The component variables of both the X and Y axes are clearly marked, with related time intervals on the X axis and uses of the Y axis identified on screen

To see news statistics for each hour (infra-day) or day (multi-day), click on the News Stack (hour/day) of interest. To see a summary of the entire period again, click anywhere in the area of the territory/sec tor/industry/company. In addition, a Snapshot function can allow a user to take screenshots of content that's of interest to them and save it on the left-hand portion of the screen. FIG. 4E shows an example where the Snapshot function has been used in the user interface of the sentiment assessment system. The user is easily able to jump to the content shown in the screenshot by clicking on it. System “memory” in this way makes comparative work easy and simplifies navigation.

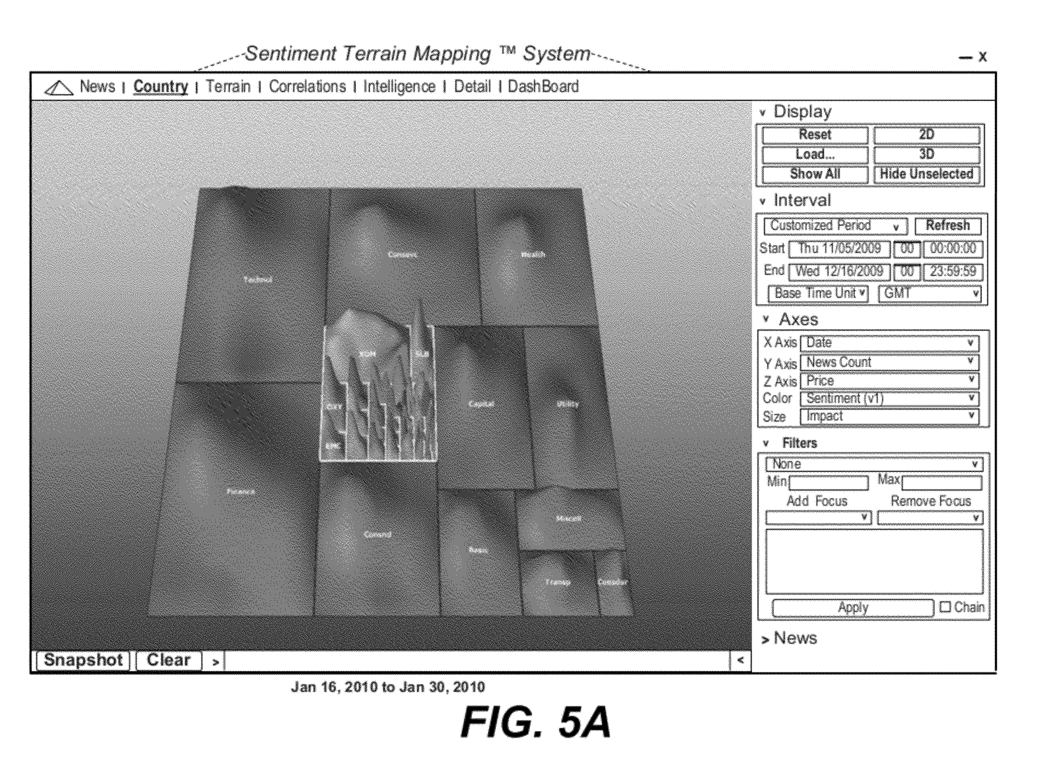

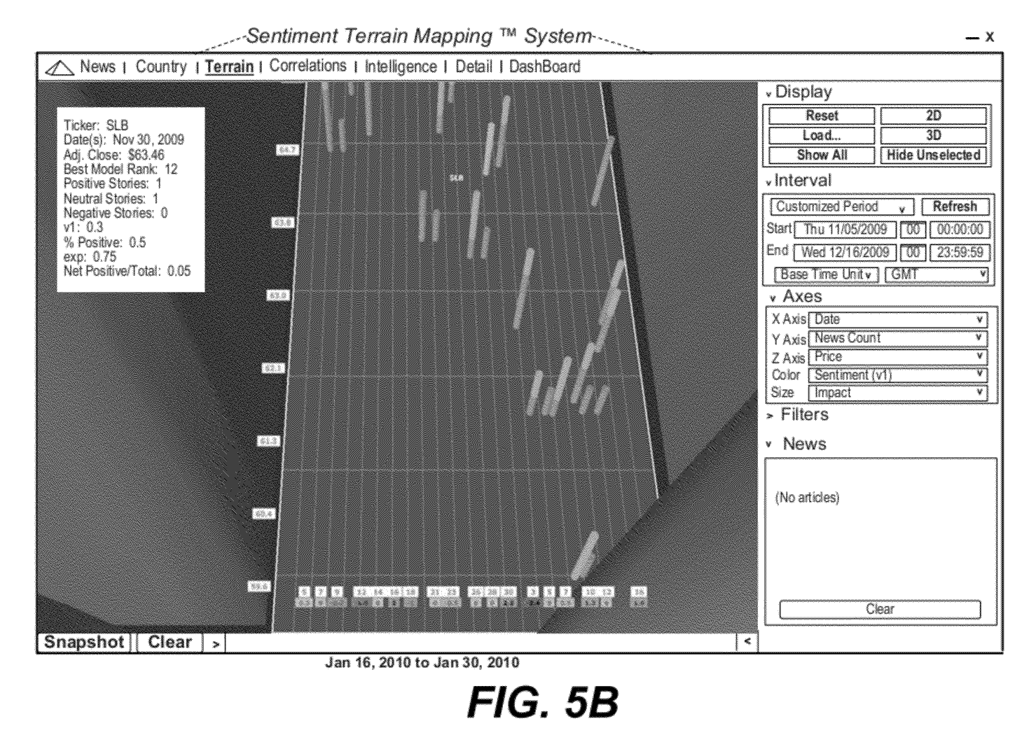

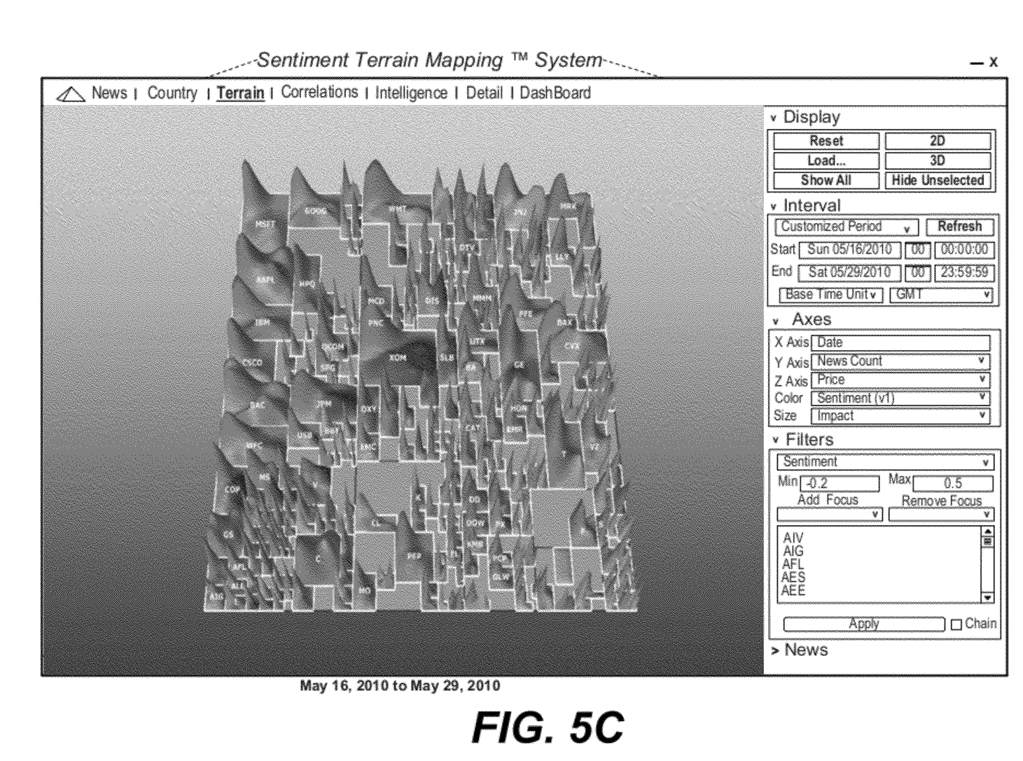

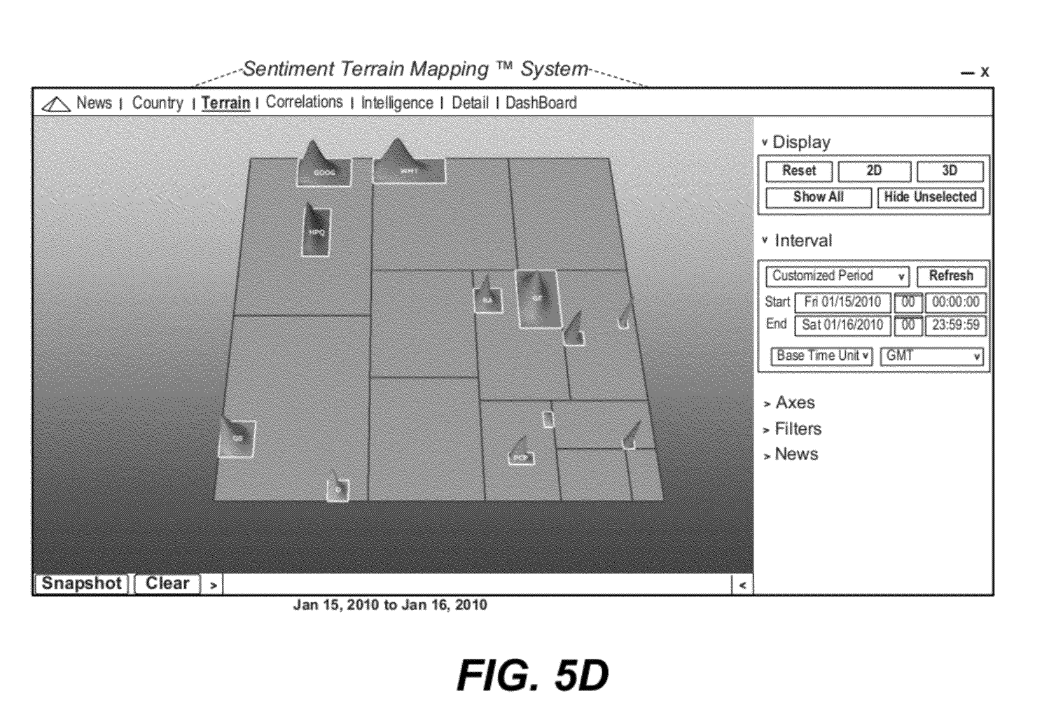

FIG. 5A shows an example of a Terrain view in a user interface of a sentiment assessment system. This screen operates at a conceptual level “below” the Country view and aggregates information from the data feed into sectors, industries, and securities for any stock universe. Functions and commands mimic those in the Country view with the exception being that the universe of data is not necessarily specific to a given territory and, therefore, the visualization is not geographically specific. Users may drill down from sector or industry level to view data associated with stocks in the universe and even individual stories related to those stocks.

FIG. 5B shows drilling down into the Terrain view in the user interface of the sentiment assessment system. The two series of numbers near the bottom of each region, along the X axis, represent the relevant time period (the upper number series) and sentiment scores (the lower number series), which are also color coded for quick assessment. The series of numbers along the left-hand side of the Y axis demarcate units of measurement appropriate to that axis.

FIG. 5C shows an example of how users can change the definition of the axes and filters to alter the display in the sentiment assessment system. As shown, the universe of inputs has been limited to display only securities with sentiment scores between −0.2 and 0.5. Such filtering is useful to portfolio managers, securities analysts, researchers, and others.

FIG. 5D shows another example of how filtering can be used in the sentiment assessment system. As shown, a user can employ filtering to identify companies (e.g., those in a supply chain) that are related to the primary company being examined. Unrelated companies are filtered out and do not visually appear.

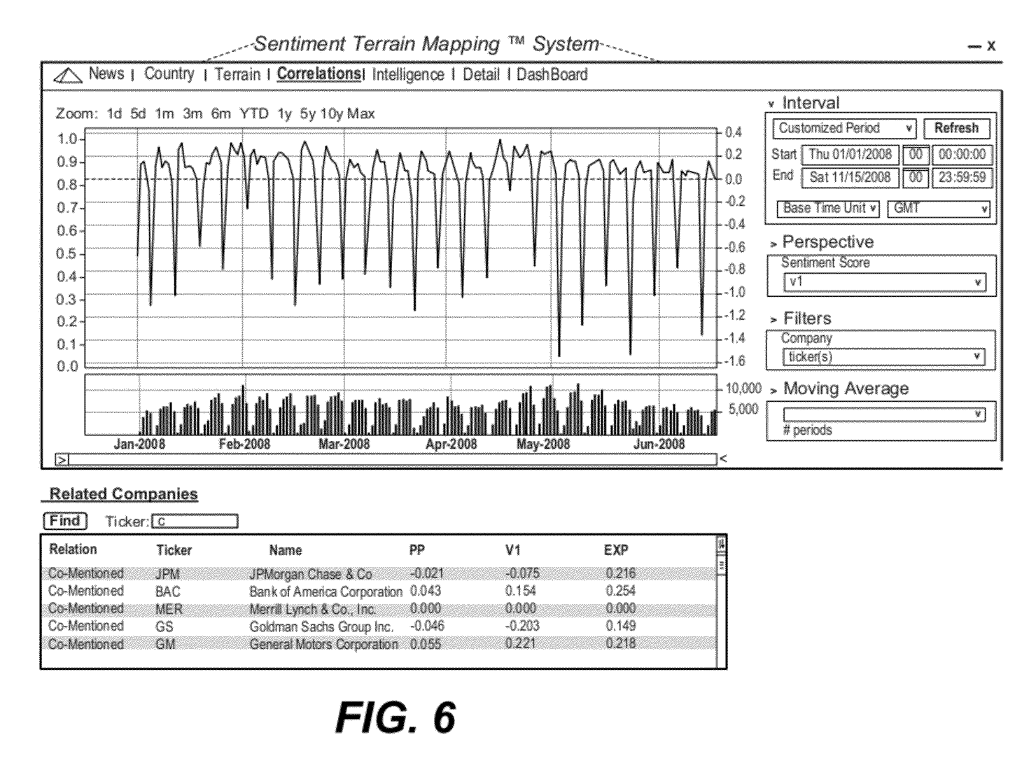

FIG. 6 shows an example of a Correlations view in a user interface of a sentiment assessment system. This view plots, in the upper half of the screen, sentiment statistics against price lines for a given period of time (user-selected). In the lower half of the screen, related companies for a given news story may be shown: identifying the type of relationship described (e.g., identifying whether the related company is co-mentioned in an article, etc.); the tickers of related companies; the company names; and the sentiment scores as the back-end system determines them.

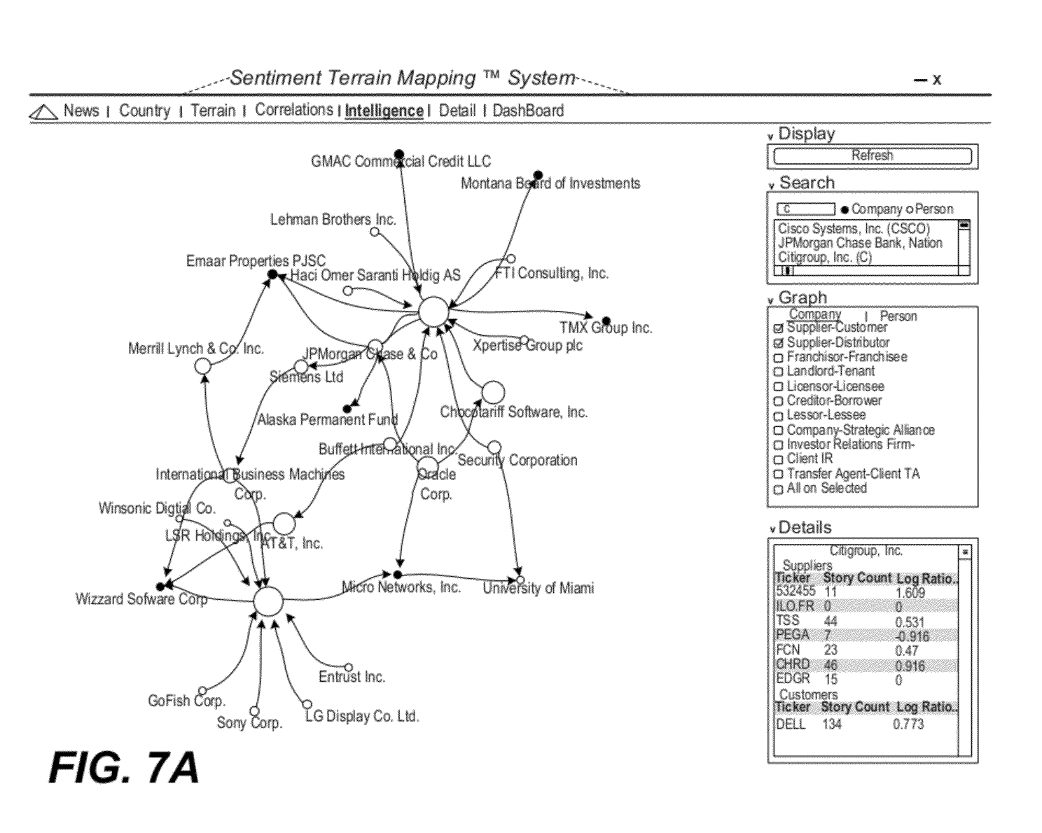

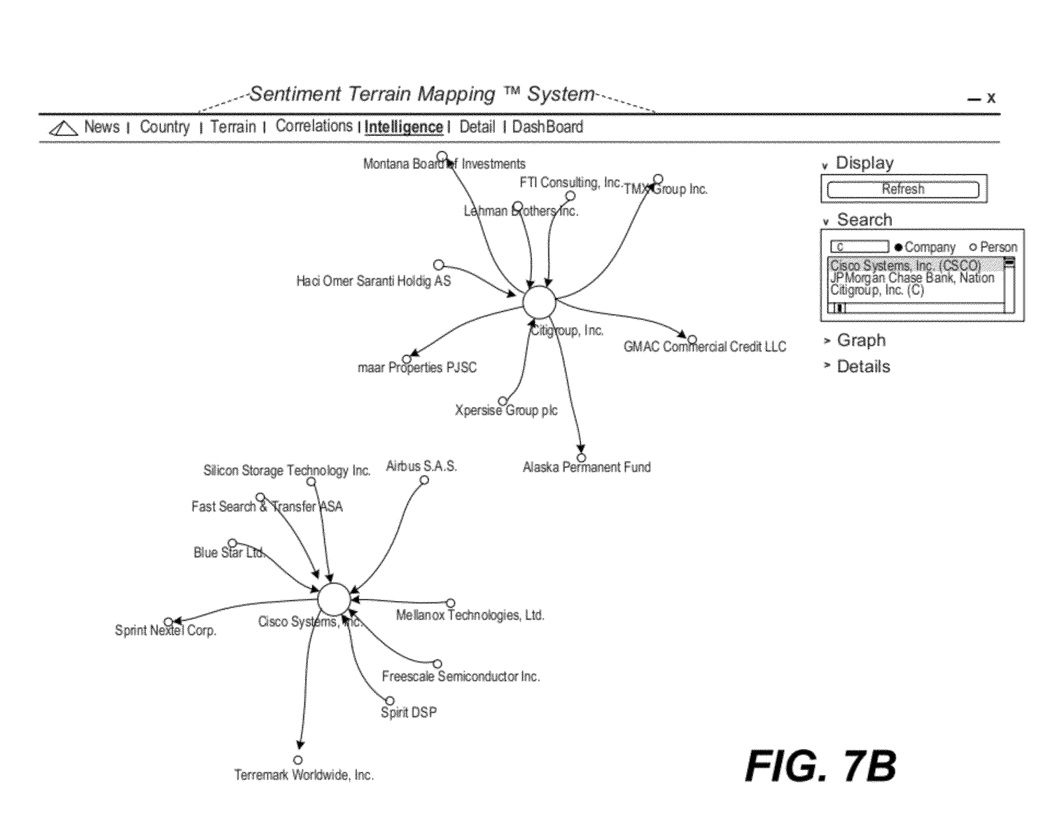

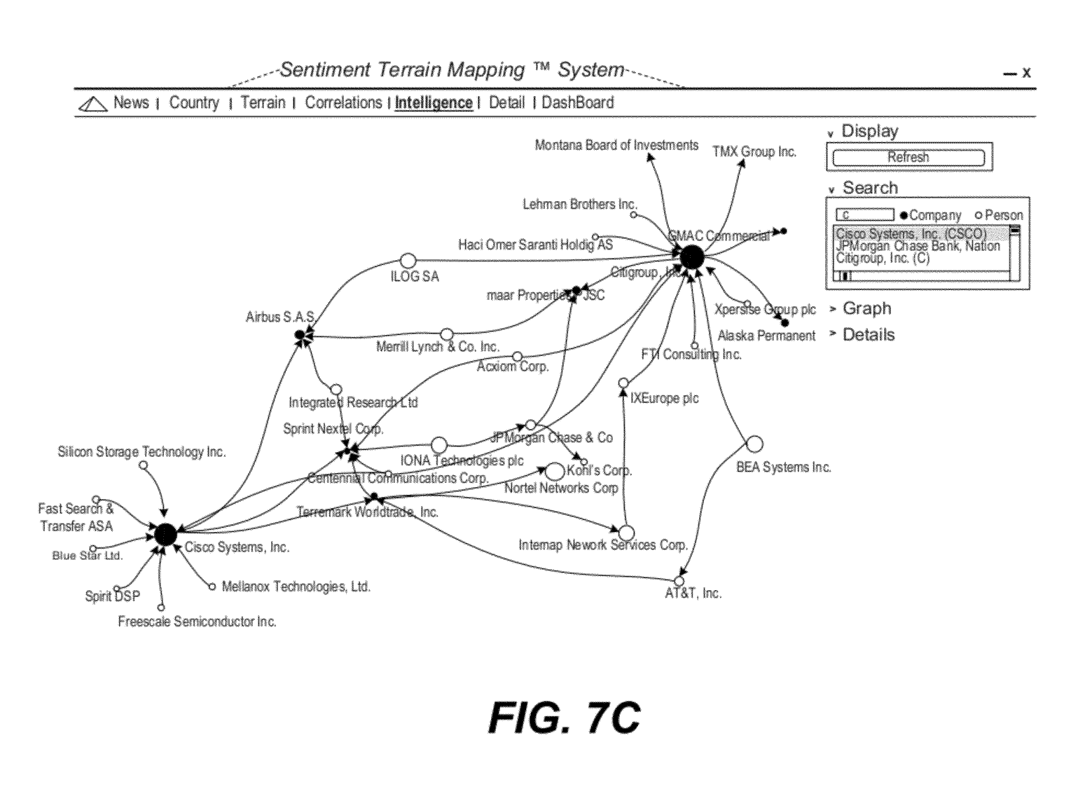

FIG. 7A shows an example of an Intelligence view in a user interface of a sentiment assessment system. This screen graphically displays a wide variety of possible relationships that are important to investors, such as a given company's supply chain, its credit relationships, its boards of directors, etc. As shown above, company-to-company relationships may be explored, as well as individual-to-individual, and company-to-individual. A node in the graph represents an entity—either a company or an individual. An edge in the graph represents a relationship between entities (such as customer-supplier; company-board member; etc). Notice that the edges are directional. Edge colors signal relationship types.

The control panel on the left-hand side gives users the opportunity to define this body of data in ways that are of interest to them: first, by determining which companies' and/or individuals' relationships to investigate; and second, by determining how those relationships should be filtered in terms of display criteria (i.e., users may ask the system only to show only relationships of a certain kind). The control panel, in the “Details” box, displays detailed information about a selected node in the graph.

When adding anew company (or individual) into the graph on the left-hand side, relationships between the entities in the graph and the newly added entity will be automatically shown. The Intelligence view also supports the display of pertinent sentiment scores for all companies shown on the screen, including those that have upstream and downstream relationships to the primary company(ies) one is investigating. Sentiment scores may be identified by color (green for positive, etc.) and/or by numeric score. Portfolio managers, analysts, and researchers will find this to be a very helpful and efficient way to stay on top of the sentiment not just assigned to a specific company but to ail related companies as well.

Users may also use the Intelligence view to discover previously unknown (to the user) relationships between a set of entities in the graph. For example, FIG. 7B shows the Intelligence view in the user interface of the sentiment assessment system with two companies' relationships displayed. As shown, the immediate relationships for Citigroup and Cisco Systems are displayed. FIG. 7C shows the Intelligence view in the user interface of the sentiment assessment system with additional relationships discovered by the system between these two companies and among their related companies. This can be greatly beneficial to researchers who need to quickly identify links between and among companies and people.

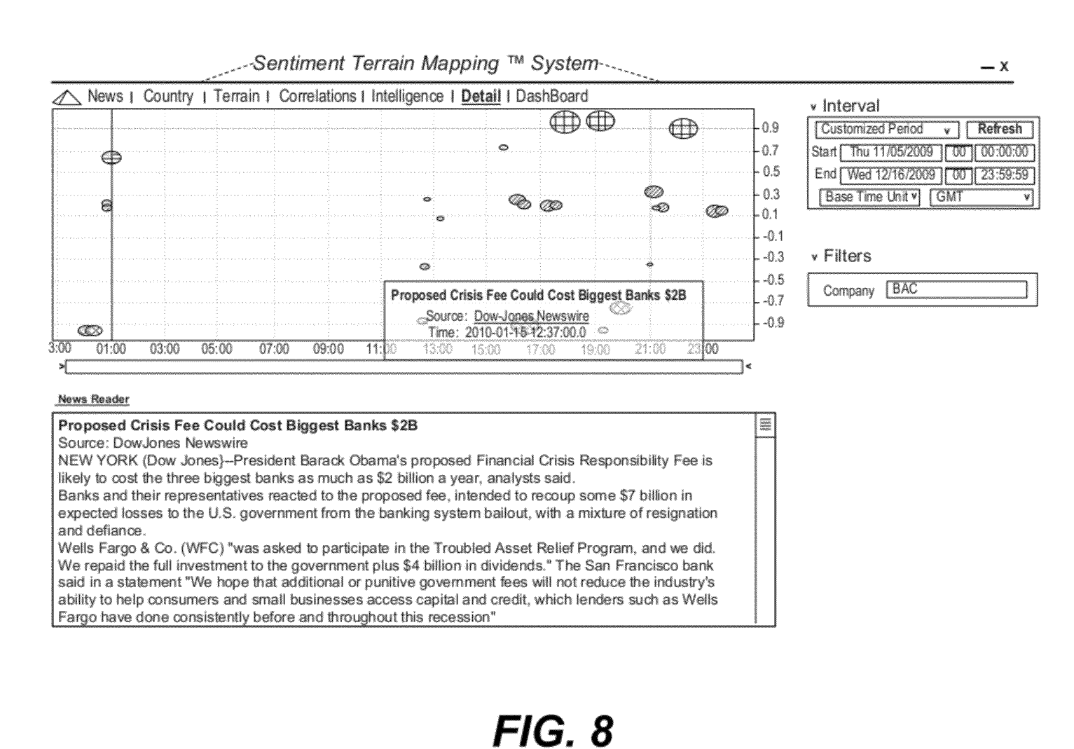

FIG. 8 shows an example of a Detail view in a user interface of a sentiment assessment system. This screen displays the time distribution of data feed inputs by hours and minutes and allows any input to be examined in detail. Each data feed input is represented as a node, color coded to signal its sentiment score (green for positive, red for negative, and grey for neutral), with size indicative of its potential impact. The horizontal axis X represents time while the vertical axis Y represents the sentiment score of each node, as scored by the back-end system. When a node is selected, an overlay information panel appears with a summary of key information. Users can limit the system to display only those feeds (e.g., news stories) relevant to a particular security or set of securities. In the lower portion of the screen, individual data feed inputs may be viewed.

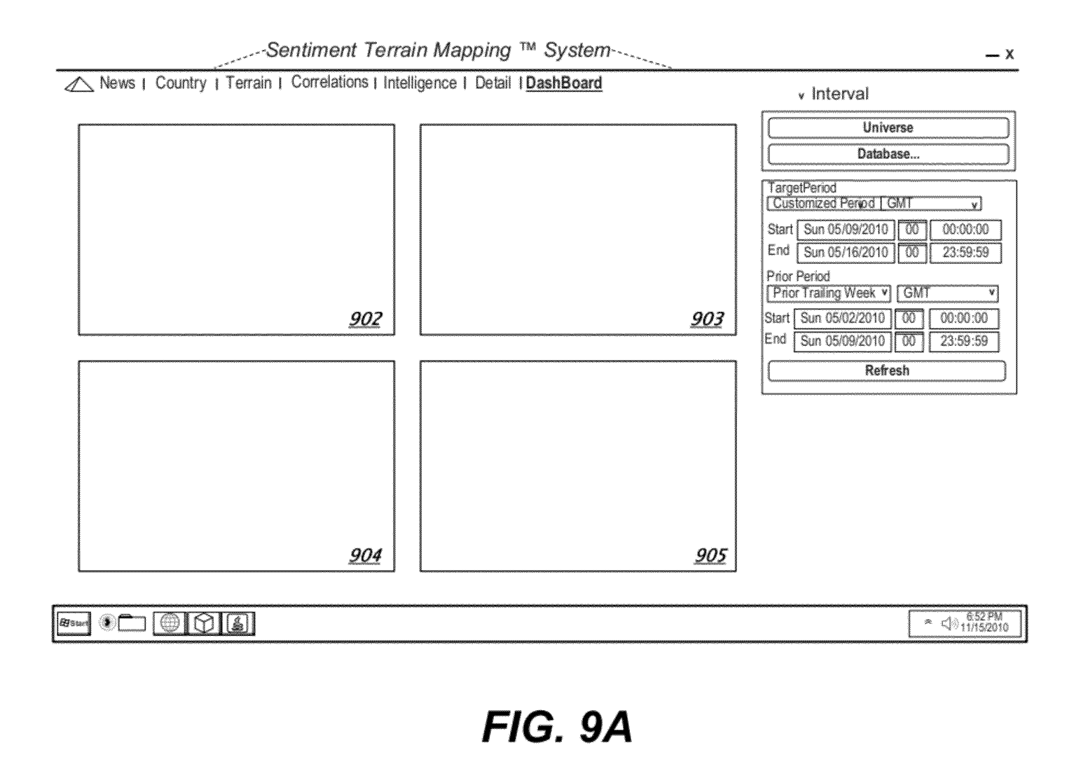

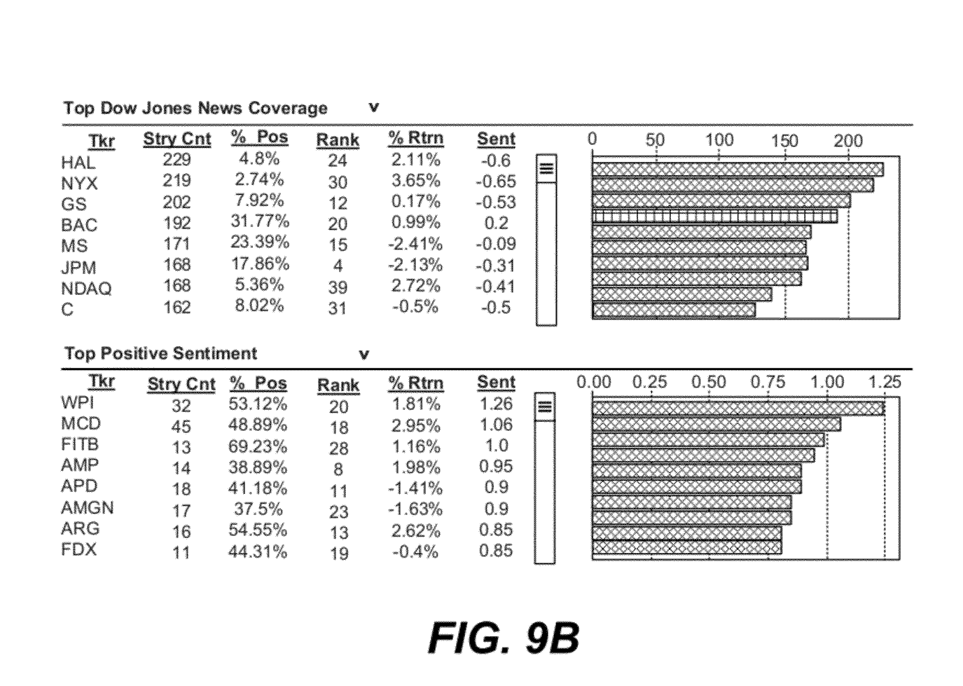

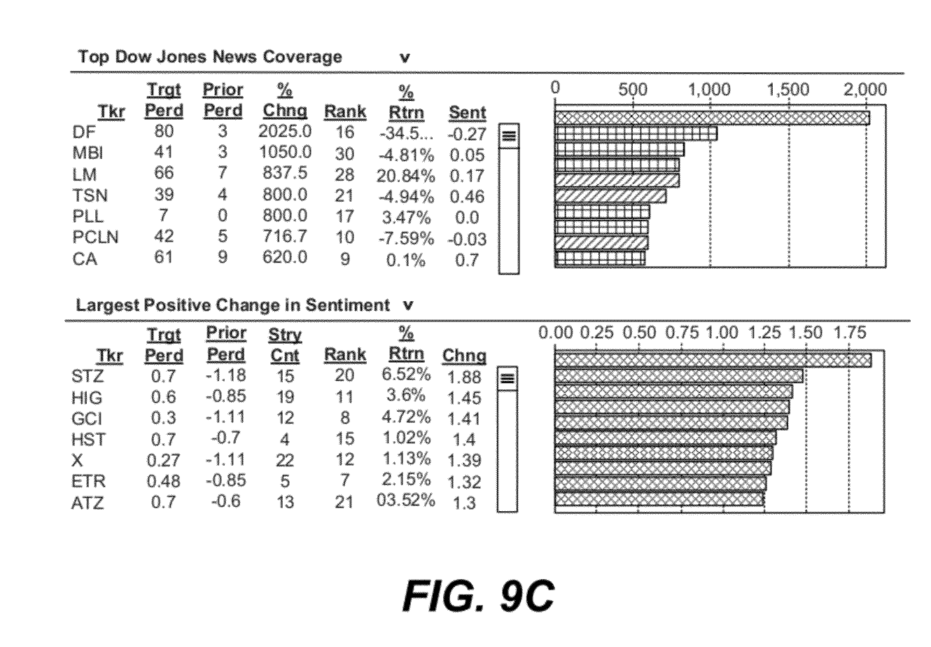

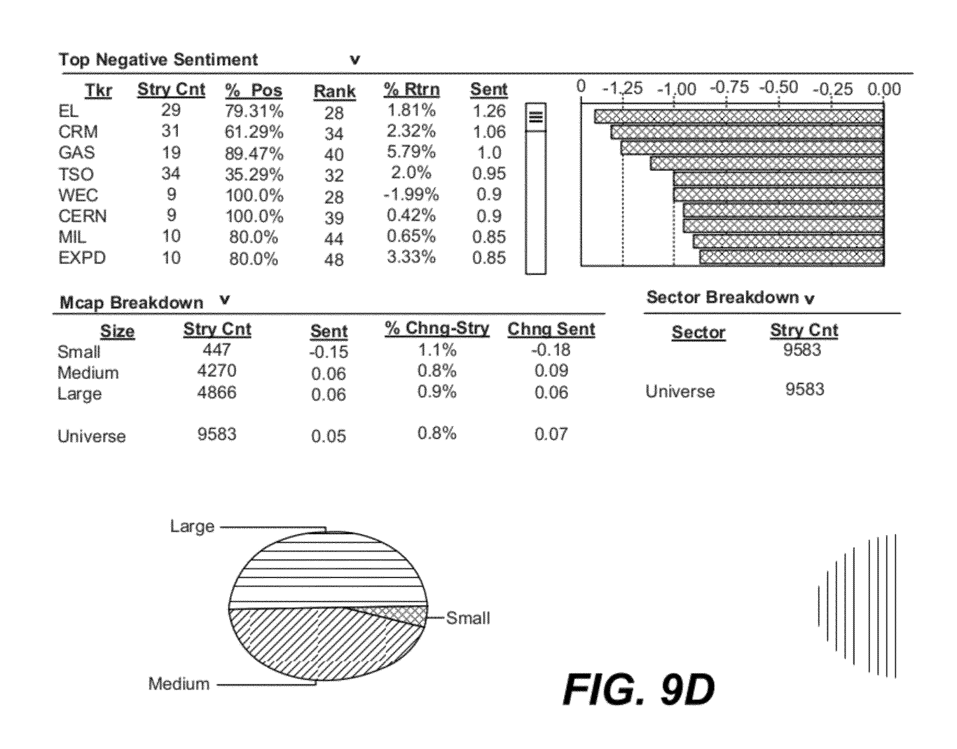

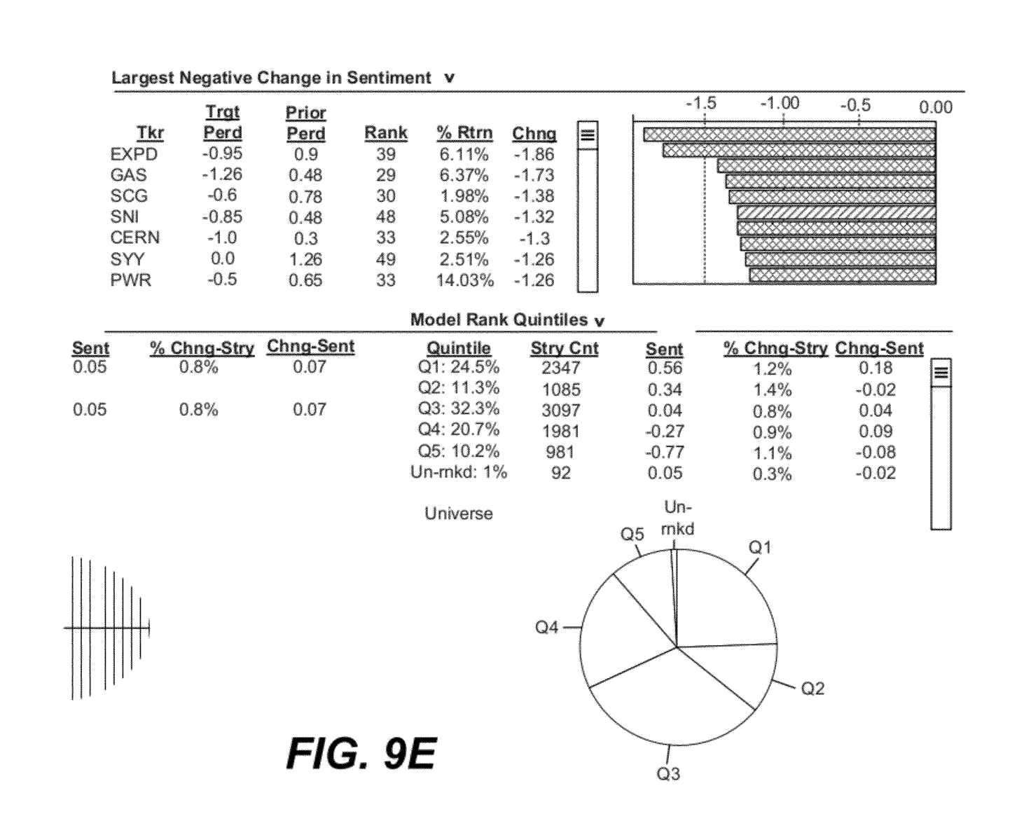

FIGs. 9A-9E show an example of a Dashboard view in a user interface of a sentiment assessment system. This screen provides summaries and rankings for stocks in a selected universe. This allows portfolio managers, analysts, researchers and others to quickly see the most critical and pertinent information. FIG. 9A shows the screen having four subsections 902, 903, 904, 905. FIG. 9B shows the details of subsection 902. FIG. 9C shows the details of subsection 903. FIG. 9D shows the details of subsection 904. FIG. 9E shows the details of subsection 905.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium. The computer-readable medium can be a machine-readable storage device, a machine-readable storage substrate, a memory0 device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. In addition, the apparatus can employ various different computing model infrastructures, such as web services, distributed computing and grid computing infrastructures.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, or a Global Positioning System (GPS) receiver, to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The invention can be used in any one of the ways or combination of ways described herein, or with any one feature emphasized to the exclusion or near-exclusion of other uses. These are just examples, and other applications are also possible. For example, the systems and techniques are applicable to industries and endeavors other than the securities industry, such as politics (e.g., visualizing sentiment regarding politicians), advertising, and marketing (e.g., visualizing sentiment regarding products for sale, such as tennis shoes). Thus, while particular embodiments of the invention have been described, other embodiments are within the scope of the following claims.

What is claimed is:

1. A method comprising:
obtaining sentiment scores and associated data, the sentiment scores assigned to entities based on emotional tone detected in obtained content;
obtaining input defining a subset of the sentiment scores and associated data to present; and
outputting a visualization corresponding to the subset of the sentiment scores and associated data.

2. The method of claim 1, wherein obtaining the sentiment scores and associated data comprises receiving the sentiment scores from a separate sentiment assessment system that automatically gathers, manages, and analyzes the content, which includes at least one of content published online or private content provided by third parties, wherein the sentiment scores are numeric values determined by the separate sentiment assessment system.

3. The method of claim 1, wherein the entities comprise companies, sectors, industries and countries, and obtaining the input comprises receiving the input through a user interface configured to allow slicing of an entire dataset according to various criteria, including countries, sectors, market capitalization, and time.

4. The method of claim 1, wherein obtaining the input comprises receiving a definition corresponding to company relationships used to filter the sentiment scores and associated data.

5. The method of claim 4, wherein receiving the definition comprises:
receiving an indication of which relationship types indicate the company relationships; and
receiving parameters to govern filtering by the indicated company relationships.

6. The method of claim 5, wherein the relationship types include supply chain relationship, credit relationship and common director relationship, and the company relationships include company-company relationships, company-individual relationships and individual-individual relationships.

7. The method of claim 1, wherein outputting the visualization comprises charting sentiment scores derived from a common data source at different times.

8. The method of claim 1, wherein outputting the visualization comprises charting sentiment scores derived from different data sources.

9. The method of claim 1, wherein outputting the visualization comprises charting sentiment scores of one or more of the entities in relation to another measure of absolute value for the one or more entities.

10. The method of claim 1, wherein outputting the visualization comprises generating a heat map user interface having reconfigurable X and Y axes, one or more drill down interfaces, and three dimensional display settings that show content volume on a Z axis.

11. A computer-readable medium encoding a computer program product operable to cause data processing apparatus to perform operations comprising:
obtaining sentiment, scores and associated data, the sentiment scores assigned to entities based on emotional tone detected in obtained content;
obtaining input, defining a subset, of the sentiment scores and associated data to present; and
outputting a visualization corresponding to the subset of the sentiment scores and associated data.

12. The computer-readable medium of claim 11, wherein the entities comprise companies, sectors, industries and countries, and obtaining the input comprises receiving the input through a user interface configured to allow slicing of an entire dataset according to various criteria, including countries, sectors, market capitalization, and time.

13. The computer-readable medium of claim 11, wherein obtaining the input comprises receiving a definition corresponding to company relationships used to filter the sentiment scores and associated data.

14. The computer-readable medium of claim 11, wherein outputting the visualization comprises generating a heat map user interface having reconfigurable X and Y axes, one or more drill down interfaces, and three dimensional display setting that shows content volume on a Z axis.

15. A system comprising:
a user interface device; and
one or more computers operable to interact with the user interface device and to perform operations comprising:
obtaining sentiment scores and associated data, the sentiment scores assigned to entities based on emotional tone detected in obtained content;
obtaining input defining a subset of the sentiment scores and associated data to present; and
outputting a visualization corresponding to the subset of the sentiment scores and associated data.

16. The system of claim 15, wherein the one or more computers comprise a server operable to interact with the user interface device through a data communication network, the user interface device comprises an access device operable to interact with the server as a client, and obtaining the sentiment scores and associated data comprises receiving the sentiment scores from a separate sentiment assessment server system that automatically gathers, manages, and analyzes the content, which includes at least one of content published online or private content provided by third parties, wherein the sentiment scores are numeric values determined by the separate sentiment assessment server system.

17. The system of claim 15, wherein obtaining the input comprises:
receiving an indication of which relationship types indicate company relationships; and
receiving parameters to govern filtering by the indicated company relationships;
wherein the relationship types include supply chain relationship, credit relationship and common director relationship, and the company relationships include company-company relationships, company-individual relationships and individual-individual relationships.

18. The system of claim 15, wherein outputting the visualization comprises charting sentiment scores derived from a common data source at different times.

19. The system of claim 15, wherein outputting the visualization comprises charting sentiment scores derived from different data sources.

20. The system of claim 15, wherein outputting the visualization comprises charting sentiment scores of one or more of the entities in relation to another measure of absolute value for the one or more entities.
